(19) United States
(12) Patent Application Publication
(10) Pub. No.: US 2006/0136086 A1
(43) Pub. Date: Jun. 22, 2006

(54) Inking process management systems and methods

(75) Inventor: Ta-Jen Chiang, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/018,795

(22) Filed: Dec. 21, 2004

(51) Int. Cl. G06F 19/00

(52) U.S. Cl. 700/115; 700/121; 700/110

(57) ABSTRACT

Systems and methods for inking process management. An inking tool generates inking map data for a first wafer. A first computer connects to an inking tool to receive the inking map data. A second computer connects to the first computer, receives the inking map data from the first computer, generates an inking map record according to the inking map data, stores the inking map record in a storage device, and generates an inking map report for the first wafer according to the inking map record.

### BACKGROUND

The invention relates to semiconductor fabrication technology, and more particularly, to systems and methods of inking process management.

A conventional semiconductor factory typically includes the requisite fabrication tools to process semiconductor wafers for a particular purpose, such as photolithography, chemical-mechanical polishing, or chemical vapor deposition. During manufacture, a semiconductor wafer passes through a series of process steps, which are performed by various fabrication tools. For example, in the production of an integrated semiconductor product, the semiconductor wafer passes through up to 600 process steps.

Typically, in order to form active devices on a semiconductor die function, the die is wrapped in ceramic or plastic packaging material for protection. Prior to sending a wafer for packaging, circuit probing (CP) tests are first performed by a wafer manufacturer in order to ensure the quality of the wafer. As the wafer manufacturer and the wafer packaging company, however, are often not located at the same facility, the wafer manufacturer typically utilizes ink to mark each defective wafer die to distinguish between good and bad wafer dies. Wafer packaging companies will only package good dies when they receive such inked wafers. The inking process is often performed in an automatic testing procedure. The automatic testing procedure utilizes a CP testing program to determine die quality. Failed dies are marked with ink. Mature semiconductor products, however, do not require to perform CP test and inking operations. Conventionally, mature semiconductor products are inked by inking tools, consuming excessive capability of inking tools. Thus, systems and methods of inking process management, are desirable.

### SUMMARY

Systems for inking process management are provided. An exemplary embodiment of an inking process management system comprises an inking tool, a first computer and a second computer. The inking tool generates inking map data for a first wafer. The first computer connects to an inking tool to receive the inking map data. The second computer receives the inking map data from the first computer, generates an inking map record according to the inking map data, stores the inking map record in a storage device, and generates an inking map report for the first wafer accordingly. The second computer may further determine that a second wafer corresponds to the first wafer, and generate a second inking map report for the second wafer according to the inking map record. Preferably, the inking map data for the first wafer is generated after completing an inking operation for the first wafer in the inking tool.

Some embodiments comprise an inking tool, a first computer and a second computer. The inking tool generates inking map data for a first wafer. The first computer connects to an inking tool to receive the inking map data. The second computer detects that an inking map record corresponding to the first wafer is absent, acquires the inking map data by issuing an inking map data request to the first computer, generates an inking map record according to the inking map data, stores the inking map record in a storage device, and generates an inking map report for the first wafer according to the inking map record. The second computer may further detect that a second wafer corresponds to the first wafer, and generate a second inking map report for the second wafer according to the inking map record.

Inking process management methods are also provided. An exemplary method of inking process management receives inking map data from a host computer connected to an inking tool, generates an inking map record according to the inking map data, stores the inking map record in a storage device and generates an inking map report for the first wafer accordingly. An embodiment of the method may further determine that a second wafer corresponds to the first wafer, and generate a second inking map report for the, second wafer according to the inking map record.

In some embodiments of inking process management method detect that an inking map record corresponding to a first wafer is absent, acquires the inking map data by issuing an inking map data request to a host computer connecting to an inking tool, generates an inking map record according to the inking map data, stores the inking map record in a storage device, and generates an inking map report for the first wafer accordingly. The method may further detect that a second wafer corresponds to the first wafer, and generate a second inking map report for the second wafer according to the inking map record.

### DESCRIPTION OF THE DRAWINGS

Inking process management systems and methods will become apparent by referring to the following detailed description of embodiments with reference to the accompanying drawings, wherein:

FIG. 1 is a diagram of an embodiment of an inking process management system;

FIG. 2 is a diagram of a hardware environment applicable to computers in employing an embodiment of inking processing management system;

FIG. 3 is a flowchart showing an embodiment of a method of inking process management for inking map report generation;

FIG. 4 is a diagram of exemplary inking map data;

FIG. 5a and 5b are diagrams of an exemplary inking map report comprising profile information;

FIG. 6 is a diagram of an exemplary inking map report comprising inking information;

FIG. 7 is a flowchart showing an embodiment of a method of inking process management for inking map record generation;

FIG. 8 is a diagram of a storage medium storing a computer program providing an embodiment of a method of inking process management.

### DESCRIPTION

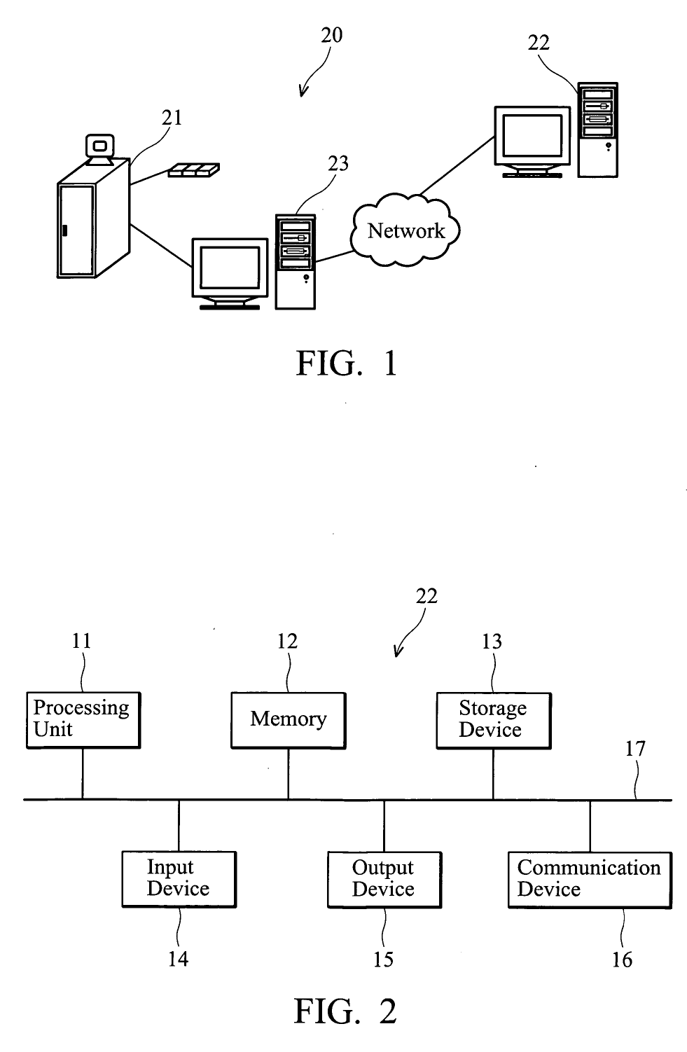

Inking process management systems and methods are provided. FIG. 1 is a diagram of an embodiment of an inking process management system. Inking process management system 20 comprises an inking tool 21, a computer 22 and a host computer 23, operates in a network (preferably Internet or Intranet) using logical connections to each other. Those skilled in the art will recognize that the inking tool 21 and computer 22 may be connected in different types of networking environments, and communicate between different types of networking environments through various types of transmission devices such as routers, gateways, access points, base station systems or others.

The inking tool 21 applies ink dots to mark bad dies on wafers according to circuit probing (CP) data or common templates for specific semiconductor products, wafer lots, or others. The inking tool 21 generates inking map data for a wafer, comprising information indicating whether a die is good or bad at a specific location. The host computer 23 connects to the inking tool 21. An Equipment Automation Program (EAP) is embedded in the host computer 23 for transferring data and issuing commands between the computer 22 and inking tool 21. Operators write numerous program codes in the EAP to control the inking tool 21, query data, and receive messages from the inking tool 21. The EAP is an event-driven program, receiving events from the computer 22 or the inking tool 21, and taking executing suitable appropriate actions. The computer 22 may follow standard procedural steps to send an inking map data request to the EAP, and the EAP takes actions to generate and transmit inking map data to the computer 22. More specifically, when receiving an inking map data request from the computer 22, the EAP makes an inking map data request to the inking tool 21, and returns relevant inking map data to the computer 22. Alternatively, after completing an inking operation on a wafer, the inking tool 21 may generate inking map data and follow a standard procedural steps to send inking map data to the EAP. The EAP takes actions to transmit inking map data to the computer 22.

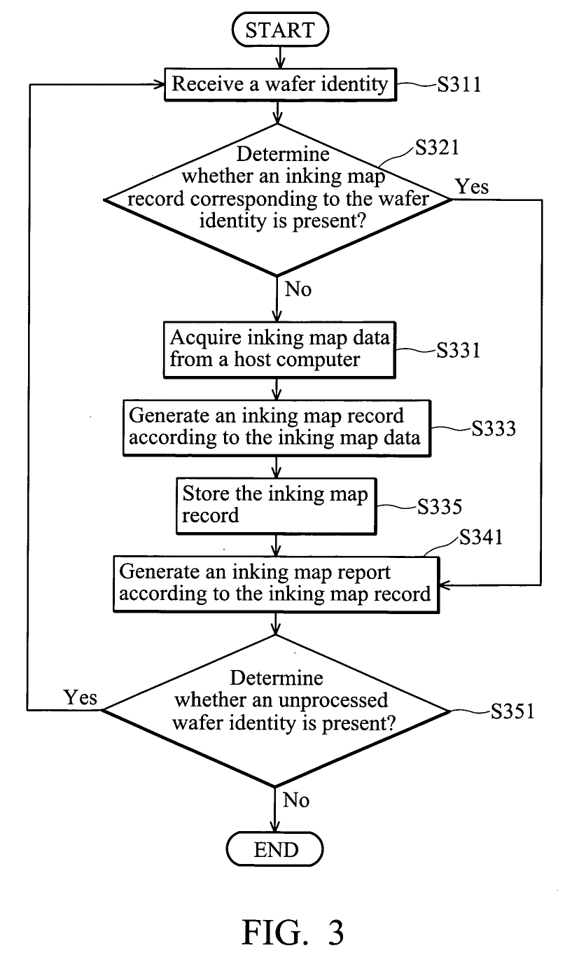

FIG. 2 is a diagram of a hardware environment applicable to computers in employing an embodiment of inking processing management system. The hardware environment of FIG. 2 includes a processing unit 11, a memory 12, a storage device 13, an input device 14, an output device 15 and a communication device 16. The processing unit 11 is connected by buses 17 to the memory 12, storage device 13, input device 14, output device 15 and communication device 16 based on Von Neumann architecture. There may be one or more processing units 11, such that the processor of the computer comprises a single central processing unit (CPU), a micro processing unit (MPU) or multiple processing units, commonly referred to as a parallel processing environment. The memory 12 is preferably a random access memory (RAM), but may also include read-only memory (ROM) or flash ROM. The memory 12 preferably stores program modules executed by the processing unit 11 to perform inking process management functions. Generally, program modules include routines, programs, objects, components, scripts, Web pages, or others, that perform particular tasks or implement particular abstract data types. Moreover, those skilled in the art will understand that some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web objects, Web Services or other similar architectures. The storage device 13 may be a hard drive, magnetic drive, optical drive, portable drive, or nonvolatile memory drive. The drives and associated computer-readable media thereof (if required) provide nonvolatile storage of computer-readable instructions, data structures and program modules. The processing unit 11, controlled by program modules received from the memory 12 and from an operator through the input device, directs inking process management functions.

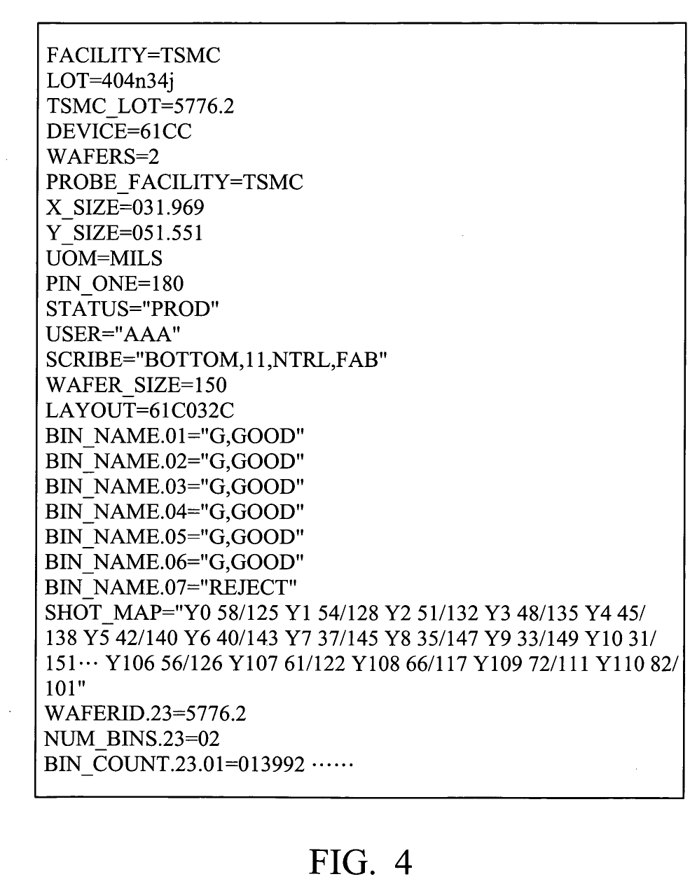

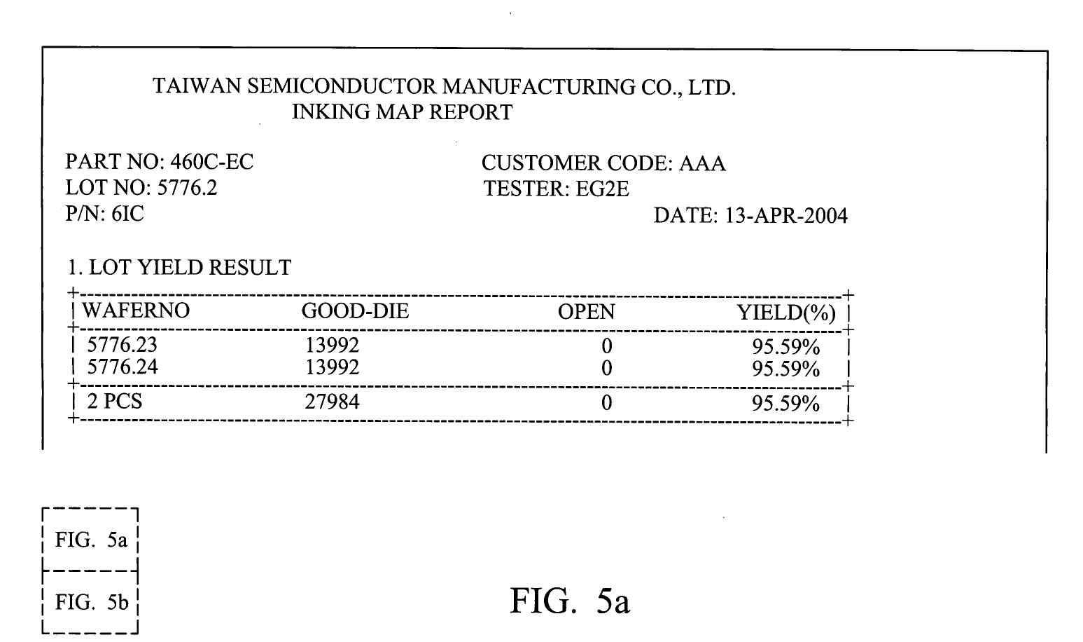

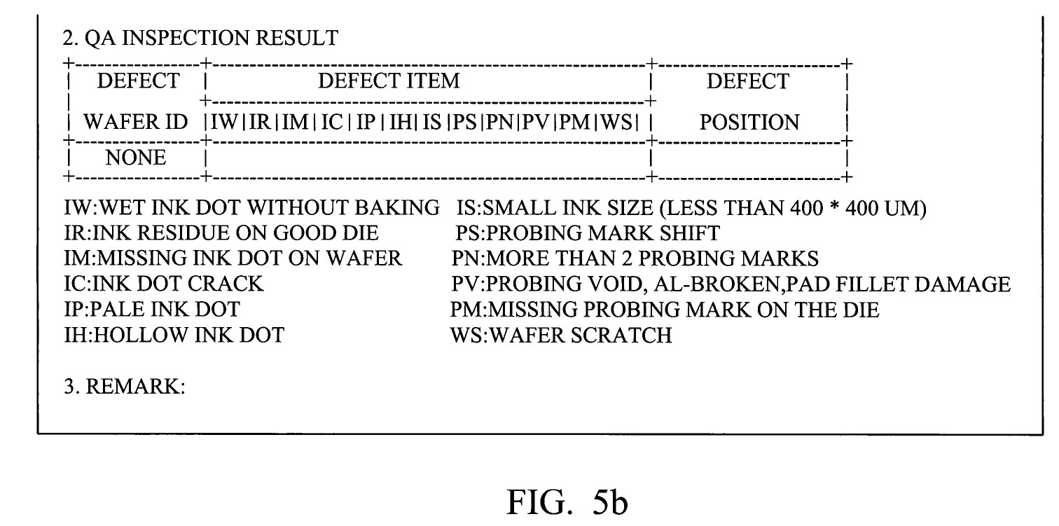

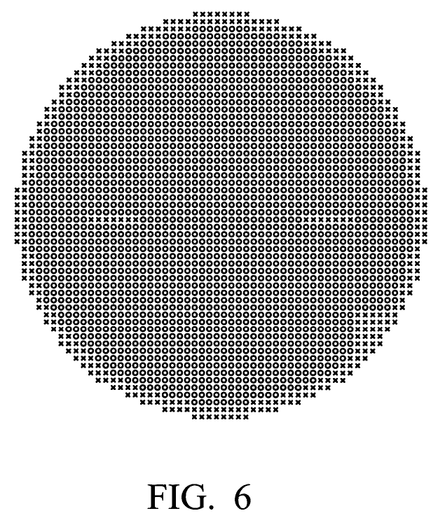

An embodiment of an inking process management method generates inking map reports, executed by the processing unit 11 in the computer 22. FIG. 3 is a flowchart showing an embodiment of a method of inking process management for inking map report generation. In step S311, a wafer identity is received. In step S321, it is determined whether an inking map record corresponding to the received wafer identity is present. If so, the process proceeds to step S341, and otherwise, to step S331. In step S331, inking map data is acquired from the host computer 23 by issuing an inking map data request. FIG. 4 is a diagram of exemplary inking map data. The inking map data describes a wafer profile, such as a wafer lot identity, device type, quantity in a lot, wafer size and the like, and inking information regarding whether a die at a specific position is good or bad. In step S333, an inking map record corresponding to the inking map data are generated. The inking map data is converted to an inking map record in a specific format, such as one or more database recordsets, datasets or data objects. The conversion, well-known in the art, is described briefly herein. In step S335, the generated inking map record is stored in the storage device 13 by executing at least one ANSI SQL query, data object method, file manipulation instruction, or others. In step S341, an inking map report is generated for the wafer identity according to the inking map record. The inking map report comprises profile and inking information for the wafer identity. FIG. 5a and 5b are diagrams of an exemplary inking map report comprising profile information. The profile information comprises yield result, part number, lot identity, customer code or others. FIG. 6 is a diagram of an exemplary inking map report 50 comprising inking information. A graph depicted in the inking map report 50 specifies whether a die at a specific location is good or bad. Note that the inking information may be represented in text, or other representations. The unmarked wafers with corresponding reports are shipped to the customers. Those skilled in the art will recognize that an inking map record may be utilized to generate hundreds to thousands inking map reports, enabling greatly reducing inking process cost.

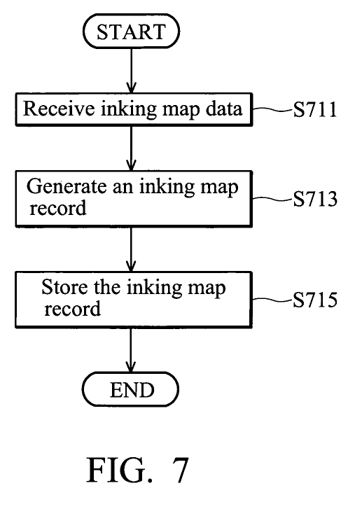

An embodiment of an inking process management method generates inking map records executed by the processing unit 11 in computer 22. FIG. 7 is a flowchart showing an embodiment of a method of inking process management for inking map record generation. In step S711, inking map data is received from the host computer 23. In step S713, an inking map record corresponding to the inking map data is generated. The inking map data is converted to an inking map record in a specific format, such as one or more database recordsets, datasets or data objects. The conversion, well-known in the art, is described briefly herein. In step S715, the generated inking map record is stored in the storage device 13 in the computer 22 by executing at least one ANSI SQL query, data object method, file manipulation instruction, or others.

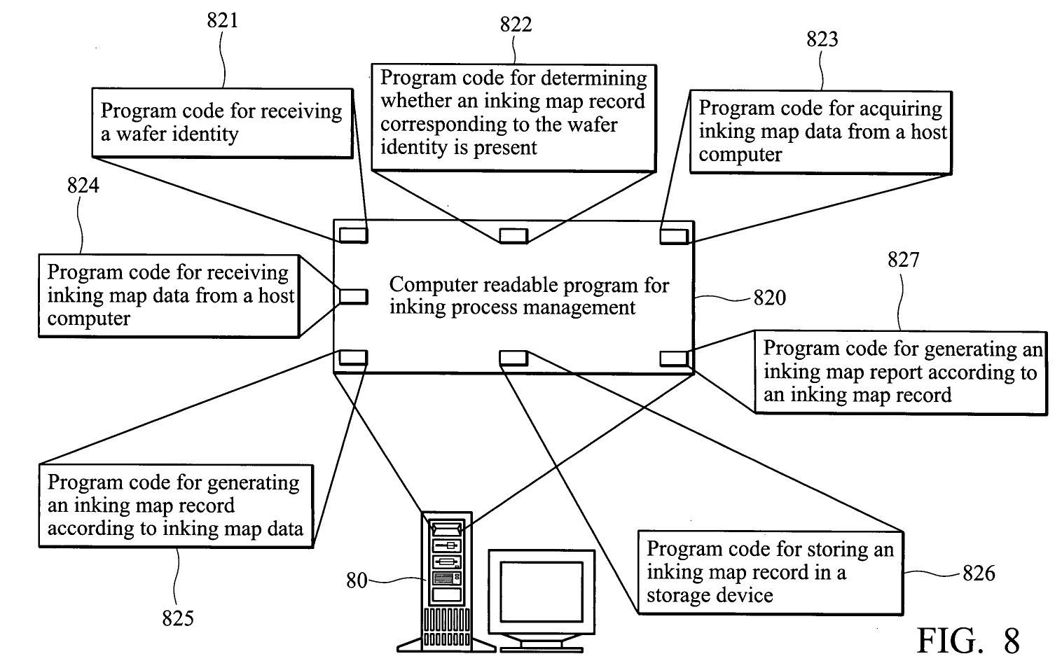

Also disclosed is a storage medium as shown in FIG. 8 storing a computer program 820 providing the disclosed method of inking process management to generate inking map records and reports. The computer program product includes a storage medium 80 having computer readable program code embodied in the medium for use in a computer system. The computer readable program code comprises at least computer readable program code 821 receiving a wafer identity, computer readable program code 822 determining whether an inking map record corresponding to the wafer identity is present, computer readable program code 823 acquiring inking map data from a host computer, computer readable program code 824 receiving inking map data from a host computer, computer readable program code 825 generating an inking map record according to inking map data, computer readable program code 826 storing an inking map record in a storage device, and computer readable program code 827 generating an inking map report according to an inking map record.

Inking process management systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not intended to limit the invention thereto. Those skilled in this technology can make various alterations and modifications without departing from the scope and spirit of the invention. Therefore, the scope of the invention shall be defined and protected by the following claims and their equivalents.

What is claimed is:

1. A system for inking process management, comprising:
an inking tool generating inking map data for a first wafer;
a first computer connecting to the inking tool, receiving the inking map data from the inking tool; and
a second computer connecting to the first computer, receiving the inking map data from the first computer, generating an inking map record according to the inking map data, storing the inking map record in a storage device, and generating an inking map report for the first wafer according to the inking map record.

2. The system of claim 1 wherein the second computer further determines that a second wafer corresponds to the first wafer, and generating a second inking map report for the second wafer according to the inking map record.

3. The system of claim 2 wherein the first inking map report describes whether a die at a specific location on the first wafer is good or bad, and the second inking map report describes whether a die at a specific location on the second wafer is good or bad.

4. The system of claim 1 wherein the first inking map report describes whether a die at a specific location on the first wafer is good or bad.

5. The system of claim 1 wherein the inking map data for the first wafer is generated after completing an inking operation for the first wafer.

6. The system of claim 5 wherein the first computer comprises an Equipment Automation Program (EAP) receiving the inking map data and transmitting the inking map data to the second computer.

7. A system for inking process management, comprising:
an inking tool generating inking map data for a first wafer;
a first computer connecting to an inking tool, receiving the inking map data from the inking tool; and
a second computer connecting to the first computer, detecting that an inking map record corresponding to the first wafer is absent, acquiring the inking map data by issuing an inking map data request to the first computer, generating an inking map record according to the inking map data, storing the inking map record in a storage device, and generating an inking map report for the first wafer according to the inking map record.

8. The system of claim 7 wherein the second computer further detects that a second wafer corresponds to the first wafer, and generates a second inking map report for the second wafer according to the inking map record.

9. The system of claim 7 wherein the first computer comprises an Equipment Automation Program (EAP) acquiring the inking map data from the inking tool after receiving the inking map data request from the second computer, and transmitting the inking map data to the second computer.

10. The system of claim 7 wherein the first inking map report describes whether a die at a specific location on the first wafer is good or bad.

11. A method of inking process management, comprising using a computer to perform the steps of:
receiving inking map data from a host computer connected to an inking tool;
generating an inking map record according to the inking map data;
storing the inking map record in a storage device; and
generating an inking map report for the first wafer according to the inking map record.

12. The method of claim 11 further comprising the steps of:
determining that a second wafer corresponds to the first wafer; and
generating a second inking map report for the second wafer according to the inking map record.

13. The method of claim 12 the first inking map report describes whether a die at a specific location on the first wafer is good or bad, and the second inking map report describes whether a die at a specific location on the second wafer is good or bad.

14. The method of claim 11 wherein the first inking map report describes whether a die at a specific location on the first wafer is good or bad.

15. The method of claim 11 wherein the inking map data for the first wafer is generated after completing an inking operation for the first wafer.

16. A method of inking process management, comprising using a computer to perform the steps of:
detecting that an inking map record corresponding to a first wafer is absent;
acquiring the inking map data by issuing an inking map data request to a host computer connecting to an inking tool;
generating an inking map record according to the inking map data;
storing the inking map record in a storage device; and
generating an inking map report for the first wafer according to the inking map record.

17. The method of claim 16 further comprising the steps of:
detecting that a second wafer corresponds to the first wafer; and
generating a second inking map report for the second wafer according to the inking map record.

18. The method of claim 16 wherein the first inking map report describes whether a die at a specific location on the first wafer is good or bad.
